(19) United States
(12) Patent Application Publication
(10) Pub. No.: US 2016/0145938 A1
(43) Pub. Date: May 26, 2016

(54) COVERING FOR AN ARCHITECTURAL OPENING HAVING COVED SLATS

(71) Applicant: HUNTER DOUGLAS INC., Pearl River, NY (US)

(72) Inventors: Wendell B. Colson, Weston, MA (US); Daniel Fogarty, Framingham, MA (US)

(21) Appl. No.: 14/899,216

(22) PCT Filed: Jun. 18, 2014
(86) PCT No.: PCT/US14/43035

§ 371 Date: Dec. 17, 2015

Related U.S. Application Data
(60) Provisional application No. 61/836,624, filed on Jun. 18, 2013.

(51) Int. Cl. E06B 9/34; B29C 51/14

(52) U.S. Cl. CPC E06B 9/34; B29C 51/14; B29L 2009/00

(57) ABSTRACT

A covering for an architectural opening is provided. The covering may include a roller, a sheet attached to the roller, and at least two slats attached to the sheet. The at least two slats may extend lengthwise across a full width of the sheet. The at least two slats may be spaced vertically apart from one another to define a gap between adjacent slats of the at least two slats. Each slat of the at least two slats may have an arcuate profile. The at least two slats and the sheet may be rolled onto and unrolled from the roller. The at least two slats may be rigid or semi-rigid to provide stiffness to the support sheet.

### CROSS-REFERENCE TO RELATED APPLICATION

This application claims the benefit under 35 U.S.C. §119(e) of U.S. Provisional Application No. 61/836,624, filed Jun. 18, 2013, and entitled “Covering for an Architectural Opening having Coved Slats”, the entire contents of which are hereby incorporated by reference herein.

### FIELD

The present disclosure relates generally to coverings for architectural openings, and more particularly to a covering having coved slats.

### BACKGROUND

Coverings for architectural openings, such as windows, doors, archways, and the like, have taken numerous forms for many years. Some coverings include a covering element that is movable between an extended position and a retracted position. In the extended position, the covering element of the covering may be positioned across the opening. In the retracted position, the covering element of the covering may be positioned adjacent one or more sides of the opening.

### SUMMARY

Examples of the disclosure may include a covering for an architectural opening. In some examples, the covering may include a roller, a sheet attached to the roller, and at least two slats attached to the sheet and extending lengthwise across a width of the sheet. The at least two slats may be spaced apart from one another to define a gap between adjacent slats of the at least two slats. The at least two slats may have an arcuate profile. The at least two slats and the sheet may be rolled onto and unrolled from the roller.

In some examples, the at least two slats have different radii relative to one another.

In some examples, the at least two slats comprise a first slat positioned adjacent an upper edge of the sheet and a second slat positioned adjacent a lower edge of the sheet, the first slat has a first radius of curvature, and the second slat has a second radius of curvature less than the first radius of curvature.

In some examples, the at least two slats have substantially the same radius as the roller.

In some examples, the at least two slats extend across an entire width of the sheet.

In some examples, the covering includes a guide frame that overlaps end portions of the at least two slats.

In some examples, the adjacent slats are parallel to one another.

In some examples, the at least two slats extend horizontally across a face of the sheet.

In some examples, the at least two slats are attached to the sheet with an adhesive.

In some examples, the at least two slats include rear faces extending coextensively with and attached to the sheet.

In some examples, the at least two slats include upper and lower edges that are attached to a face of the sheet.

In some examples, the sheet is constructed of one piece of material.

In some examples, the gap has a constant width along the length of the adjacent slats.

In some examples, the gap has a width that is less than a width of the adjacent slats.

In some examples, a width of each slat of the at least two slats is about one inch.

In some examples, the at least two slats are comprised of one or more materials selected from the group of materials including polyvinylchloride, thermoplastic polymers, thermosetting polymers, aluminum, wood veneer, fiberglass, nonwoven, or coated fabrics.

In some examples, the sheet is comprised of one or more materials selected from the group of materials including polymer coated woven glass yarns, polymer coated woven polyester yarns, knits, woven, nonwoven, or film.

Examples of the disclosure may include a method of assembling a covering for an architectural opening. In some examples, the method includes attaching at least two slats to a sheet, rolling the sheet and the at least two slats about a roller to mechanically conform a shape of the at least two slats to a radius of curvature defined at least partially by the roller, and heating the at least two slats after conforming the shape the at least two slats to the radius of curvature defined at least partially by the roller.

In some examples, the method includes cooling the at least two slats after heating the at least two slats to set the radius of curvature of the at least two slats.

In some examples, the attaching at least two slats to a sheet comprises attaching at least two slats having a rectangular profile to a sheet.

The disclosure is given to aid understanding, and one of skill in the art will understand that each of the various aspects and features of the disclosure may advantageously be used separately in some instances, or in combination with other aspects and features of the disclosure in other instances. Accordingly, while the disclosure is presented in terms of examples, it should be appreciated that individual aspects of any example can be claimed separately or in combination with aspects and features of that example or any other example.

It should be understood that the drawings are not necessarily to scale. In certain instances, details that are not necessary for an understanding of the disclosure or that render other details difficult to perceive may have been omitted. It should be understood that the claimed subject matter is not necessarily limited to the particular examples or arrangements illustrated herein.

### BRIEF DESCRIPTION OF THE DRAWINGS

The accompanying drawings, which are incorporated in and form part of the specification in which like numerals designate like parts, illustrate examples of the present disclosure and together with the description, serve to explain the principles of the disclosure.

FIG. 1 is a front perspective view of a covering for an architectural opening in accordance with an example of the present disclosure.

FIG. 2 is a front perspective view of a covering element of the covering of FIG. 1 in accordance with an example of the present disclosure.

FIG. 3 is a rear perspective view of the covering element of FIG. 2 in accordance with an example of the present disclosure.

FIG. 4 is a front elevation view of the covering element of FIG. 2 in accordance with an example of the present disclosure.

FIG. 5 is a fragmentary, front perspective view of the covering of FIG. 1 with a portion of a guide frame cut away to show the engagement of the covering element of FIG. 2 with a side track of the guide frame.

FIG. 6 is a schematic diagram of the covering element of FIG. 2 partially wrapped about a roller of the covering of FIG. 1 in accordance with an example of the present disclosure.

FIG. 7 is a schematic diagram of a portion of the covering element of FIG. 2 prior to shaping the slats in accordance with an example of the present disclosure.

FIG. 8 is a schematic diagram of a portion of the covering element of FIG. 7 being wrapped about a roller to mechanically conform the slats to the radius of curvature of the roller in accordance with an example of the present disclosure.

FIG. 9 is a schematic diagram of a portion of the covering element of FIG. 7 wrapped about a roller during heat application for shaping the slats in accordance with an example of the present disclosure.

### DETAILED DESCRIPTION

The present disclosure generally provides a covering for an architectural opening. The covering may include a retractable covering element. The covering element may include a support sheet and a plurality of slats attached to the support sheet. The support sheet may be water repellant or resistant for exterior applications, for example. The slats may have an arcuate or curved profile (or cross-section) and may be referred to as arcuate, curved, or coved slats.

The slats may function as stiffening members and may be referred to as battens. The slats may stiffen the lateral edges of the support sheet to prevent or substantially prevent the lateral edges of the support sheet from curling when the support sheet is extended from a roller. As such, the slats may enable the use of support sheets that would not otherwise be suitable for roll-screen applications. Additionally or alternatively, the slats may facilitate insertion of the support sheet into side tracks of a frame, such as that described in international patent application number PCT/US2011/039473, which published as international publication number WO/2011/156395, and is hereby incorporated by reference herein in its entirety. The slats may extend lengthwise across a face of the support sheet along the entire width of the support sheet to provide cross-directional stiffness to the support sheet. The slats may reduce or substantially prevent wrinkling, induced by a deflecting or sagging roller, from projecting downwardly along the length of the support sheet, which may enable the use of a smaller outer diameter roller and/or a longer roller. A rear face of the slats may be attached to a corresponding face of the support sheet.

The support sheet may be attached to a roller (e.g., a roller tube), which may be rotationally supported by bearing points, which may be positioned within a head rail. An upper edge of the support sheet may be attached to the roller. The slats may have an arcuate, coved, or curved profile defined by a radius of curvature that is comparable (e.g., equivalent or substantially equivalent) to the radius of curvature of the roller. The comparable radii of the slats and the roller may provide a tight roll-up diameter of the support sheet and slats about the roller, thereby reducing the space required at the top of the covering to store a fully-retracted covering element. In some implementations, the radius of curvature of the slats increases as the roll-up diameter of the roller, support sheet, and slats increases. When in an extended position, the slats may provide light blocking and/or a depth dimension to the support sheet, which is typically a substantially two-dimensional product. When in the extended position, the support sheet may provide water repellence or resistance, which may be particularly useful for exterior applications.

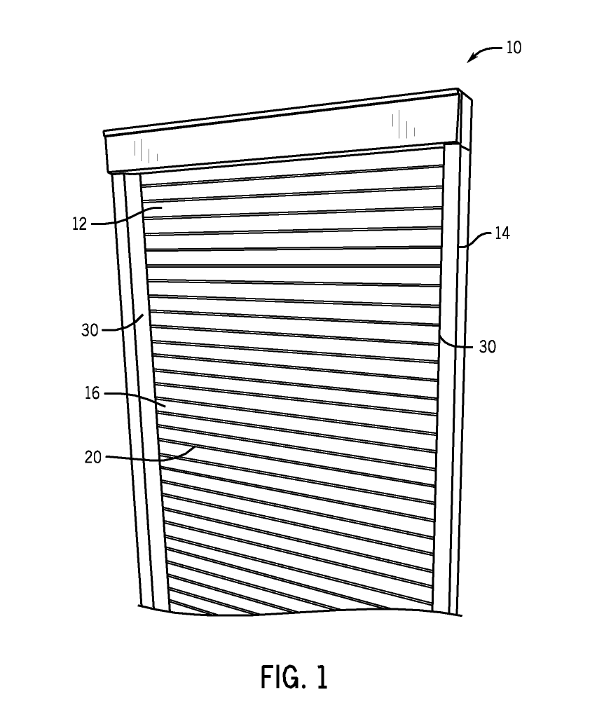

Referring to FIG. 1, the covering 10 may include a moveable covering element 12 and a guide frame 14. The covering element 12 may be referred to as a screen, a roll screen, or a battened roll screen. The covering element 12 may be moveable between a fully extended position where the covering element 12 is positioned across the architectural opening and a fully retracted position where the covering element 12 is positioned adjacent one or more sides of the opening. The covering element 12 may include multiple slats 16. The slats 16 may be oriented perpendicularly or substantially perpendicularly to a travel direction of the covering element 12. In some implementations, the slats 16 extend horizontally or substantially horizontally across the architectural opening, and the covering element 12 is moveable in a vertical or substantially vertical direction.

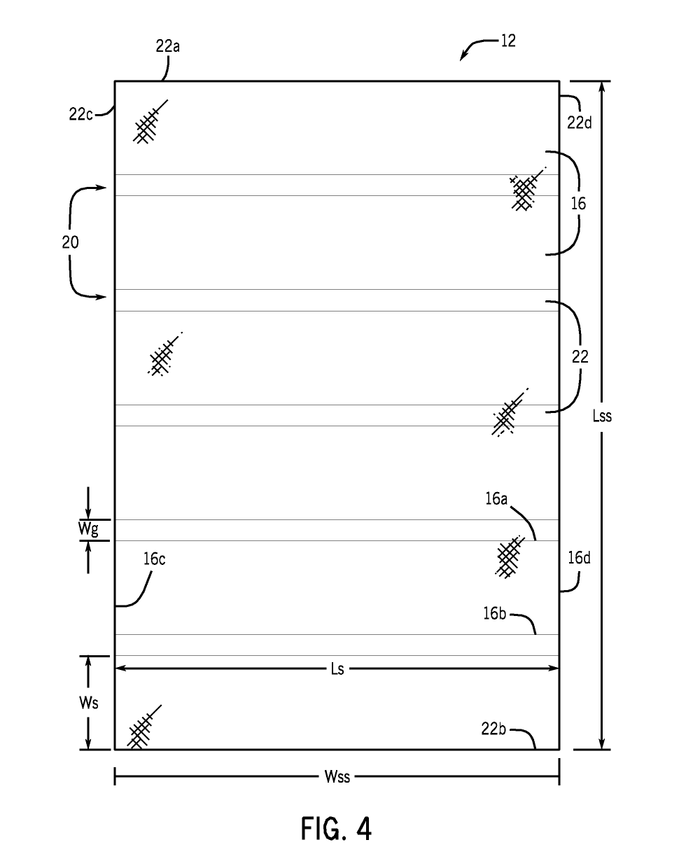

Referring to FIGS. 1-5, the slats 16 may be spaced apart from one another to define a gap 20 between adjacent slats 16. In some implementations, the gaps 20 extend horizontally across the covering element 12 and define a vertical separation between adjacent slats 16. The slats 16 may extend parallel or substantially parallel to one another, and the gaps 20 between adjacent slats 16 may have consistent widths along the length of the slats 16. The width Wg of the gaps 20 defined by the distance between subsequent slats 16 may be equal to, greater than, or less than the width Ws of the slats 16 defined by the distance between upper and lower edges 16a, 16b of the slats 16 (see FIG. 4). In some implementations, the slats 16 have a width Ws of between about one-half of an inch and about 2 inches. In some implementations, the slats 16 have a width Ws of between about three-quarters of an inch and about one and one-half inches. In some implementations, the slats 16 have a width Ws of about 1 inch. In some examples, the slats 16 have a width in a flat configuration of about 0.5 inches to about 2 inches. In some examples, the slats 16 have a width in a flat configuration of about 1.25 inches. In some examples, the slats 16 have a thickness of between about 10 mils (i.e., 0.010 inches) and about 15 mils (i.e., 0.015 inches). The gaps 20 between subsequent slats 16 may be equal to one another or vary. In some implementations, the gaps 20 between adjacent slats 16 have different widths. In some implementations, the slats 16 have different widths.

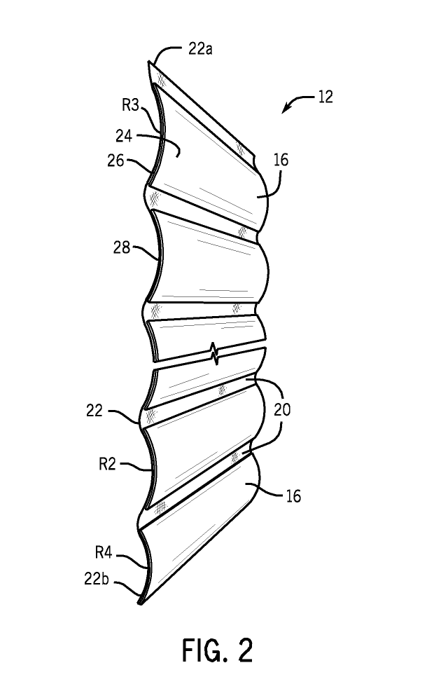

Referring to FIGS. 2-4, the covering element 12 may include a support sheet 22 having a length Lss defined by the distance between an upper edge 22a and a lower edge 22b of the support sheet 22. The length Lss of the support sheet 22 may extend in a travel direction of the covering element 12. The support sheet 22 may have a width Wss defined by the distance between opposing side edges 22c, 22d of the support sheet 22. The width Wss of the support sheet 22 may extend perpendicularly or substantially perpendicularly to the travel direction of the covering 12. The support sheet 22 may be rectangularly shaped.

With continued reference to FIGS. 2-4, the slats 16 may be attached to the support sheet 22. The support sheet 22 may be exposed or visible through the gaps 20 formed between the slats 16. The slats 16 may have a length Ls defined by the distance between opposing ends 16c, 16d of the slats 16. The length Ls of the slats 16 may be equal or substantially equal to the width Wss of the support sheet 22. The ends 16c, 16d of the slats 16 may be aligned or substantially aligned with the side edges 22c, 22d of the support sheet 22. In some implementations, the upper and lower edges 16a, 16b of the slats 16 may be attached to the support sheet 22 along the length Ls of the slats 16.

With continued reference to FIGS. 2-4, each slat 16 may have a front face 24 and a rear face 26. The distance between the front face 24 and the rear face 26 of each slat 16 may define a single, uniform thickness of the respective slat 16. The front faces 24 may be directed away from the support sheet 22 and may be visible from an interior or exterior side of the architectural opening depending on the orientation of the covering 10 within the architectural opening. The front faces 24 may have a convex shape. The entire rear face 26 of each slat 16 may be contiguous with the support sheet 22. The rear faces 26 may have a concave shape.

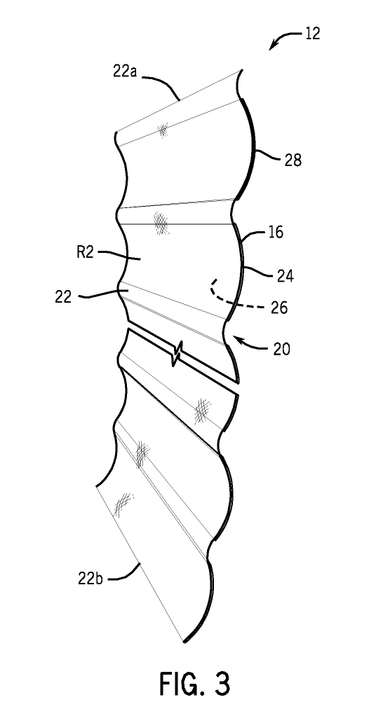

Referring still to FIGS. 2-4, the slats 16 may be laminated to the support sheet 22 with an adhesive 28. The rear face 26 of each slat 16 may be attached to a confronting face of the support sheet 22. The adhesive 28 may be coated over the entire rear face 26 of each slat 16. In some implementations, extra adhesive 28 may be applied at the edges of the rear face 26 of the slats 16. In some implementations, the slats 16 may be adhered to the support sheet 22 with a copolyester hot melt adhesive. When the slats 16 are attached to the support sheet 22, the support sheet 22 may conform to the concave shape of the rear faces 26 of the slats 16 (see FIGS. 2 and 3). The shape of the support sheet 22 between adjacent slats 16 may be opposite the concave shape of the rear faces 26. The curvature or concavity of the support sheet 22 may change signs along the upper and lower edges 22a, 22b of the slats 16. In other words, the attachment of the support sheet 22 to the rear faces 26 of the slats 16 may define inflection points of the support sheet 22 along the upper and lower edges 22a, 22b of the slats 16. In some implementations, the slats 16 are attached intermittently along the length of rear faces 26. In some implementations, the slats 16 are attached along substantially the entire width Ws of the slats 16.

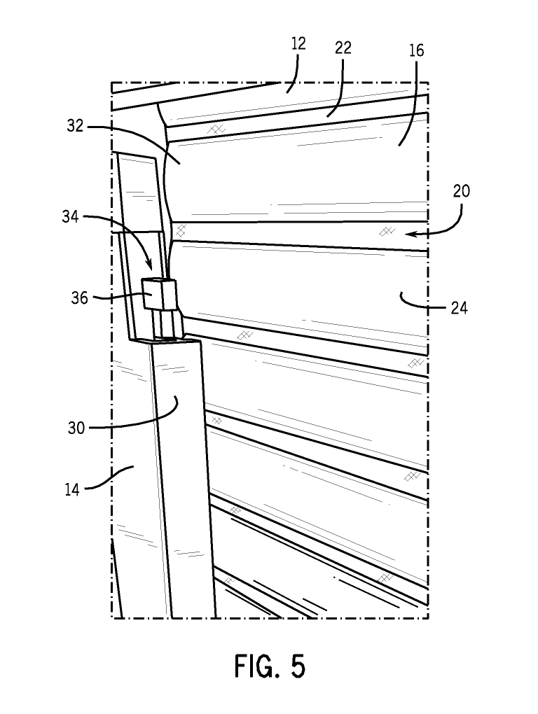

Referring to FIGS. 1-5, the slats 16 may be sufficiently rigid to prevent or substantially prevent bending of the slats 16. When applied to the support sheet 22, the slats 16 may provide the support sheet 22 with cross-sheet stiffness, and the slats 16 may be referred to as battens. In some implementations, the slats 16 stiffen the support sheet 22 such that the covering member 12 is self-supporting. The slats 16 may provide stiffness across the full width Wss of the support sheet 22 and may prevent or substantially prevent the covering element 12 from being untracked from the guide frame 14 (see FIGS. 1 and 5). The slats 16 may provide stiffness to the opposing side edges 22c, 22d of the support sheet 22 to prevent or substantially prevent curling of the side edges 22c, 22d, thereby enabling the use of fabrics that would not otherwise be suitable for roll-screen applications. The slats 16 may provide sufficient cross-sheet stiffness to the support sheet 22 such that the slats 16 reduce wrinkling of the support sheet 22, which may be caused by deflection or sagging of the roller 38 along the length of the roller 38. The stiffening effect of the slats 16 may enable the use of smaller outer diameter and/or longer rollers 38 since the slats 16 may counteract the wrinkling of the support sheet 22 caused by deflection or sagging of the roller 38. In some examples, the use of smaller outer diameter rollers 38 may significantly reduce the size of a head rail box of the covering 10, especially for applications requiring a relatively long roller, such as a length of ten feet or more. In some examples, the slats 16 may prevent or substantially prevent wrinkles caused by deflection or sagging of the roller 38 from projecting downwardly through the covering element 12.

Referring to FIGS. 1 and 5, the guide frame 14 may include a pair of side tracks 30 positioned along opposing sides of the covering element 14. The slats 16 of the covering element 14 may extend lengthwise between the side tracks 30 of the guide frame 14. The slats 16 may be oriented perpendicularly or substantially perpendicularly to the side tracks 30. For example, the slats 16 may be oriented horizontally or substantially horizontally, and the side tracks 30 may be oriented vertically or substantially vertically. Opposing end portions of the slats 16 may be received within the side tracks 30 to guide the covering element 12 during extension and retraction of the covering element 12.

Referring to FIG. 5, the guide frame 14 may overlap the end portions 32 of the slats 16. The slats 16 may span across the width Wss of the support sheet 22 between the side tracks 30 of the guide frame 14 to provide the support sheet 22 with sufficient cross-sheet stiffness to prevent or substantially prevent the covering element 12 from bending and untracking from the guide frame 14. The side tracks 30 of the guide frame 14 may include an alignment guide 34 positioned above the side tracks 30 to guide the covering element 12 downwardly into the tracks 30. The alignment guide 34 may include a pair of opposing vertical guides 36 to locate the covering element 12 widthwise, depthwise, or both within the guide frame 14 and align the covering element 12 when entering the side tracks 30. One of the vertical guides 36 may be positioned along the front faces 24 of the slats 16 (see FIG. 5), and the other of the vertical guides (not shown) may be positioned along the rear faces 26 of the slats 16. The vertical guides 36 may be mirror images of each other. The vertical guides 36 may be substantially rectangular. It should be appreciated that due to the stiffness of the slats 16 across the width Wss of the support sheet 22, the covering element 12 may not be easily folded or bent in an out-of-plane direction and thus may not be easily untracked from the side tracks 30. If the covering 10 becomes untracked, then the covering 10 may be retracked pursuant to the teaching of international patent application number PCT/US2011/039473.

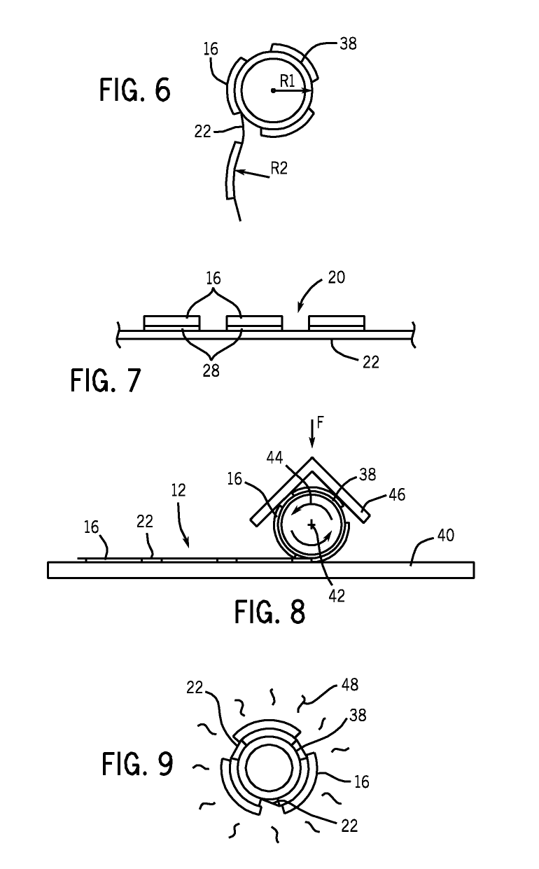

With reference to FIG. 6, the covering 10 may include a roller 38 rotateable about a central longitudinal axis. The roller 38 may be formed as a tube and may have an outer surface defining a radius R1 of the roller 38. The covering element 12 may be rolled onto and off of the roller 38 to retract and extend the covering element 12 across the architectural opening. In some implementations, the upper edge 22a of the support sheet 22 is attached to the roller 38. Rotation of the roller 38 in a first direction may wrap the support sheet 22 and the slats 16 about the roller 38 to retract the covering element 12 to one or more sides of the architectural opening. Rotation of the roller 38 in a second direction opposite the first direction may unwrap the support sheet 22 and the slats 16 from the roller 38 to extend the covering element 12 across the architectural opening. In some implementations, the support sheet 22 extends off of a front side of the roller 38.

Referring to FIGS. 2 and 3, the slats 16 may have an arcuate, coved, or curved profile. Each slat 16 may be formed as an arc segment defined by a single radius R2. The radius R2 of the slats 16 may substantially match the radius R1 of the roller 38. By substantially matching the radii R1, R2 of the roller 38 and the slats 16, the covering element 12 may roll tightly onto the roller 38, resulting in a smaller overall roll-up diameter of the covering element 12 about the roller 38.

In some implementations, the covering element 12 may include slats 16 having different radii relative to one another. For example, a slat 16 attached to the support sheet 22 adjacent the upper edge 22a of the support sheet 22 may have a smaller radius of curvature R3 than a radius of curvature R4 of a slat 16 attached to the support sheet 22 adjacent the lower edge 22b of the support sheet 22 (see FIG. 2). The difference in radii R3, R4 may be due to differences in the effective diameter of the roller 38 at the point the subject slat 16 is wound onto the roller 38. For example, the slat 16 attached to the support sheet 22 adjacent the lower edge 22b of the support sheet 22 may have a larger radius of curvature R4 than the radius of curvature R3 of the slat 16 attached to the support sheet 22 adjacent the upper edge 22a of the support sheet 22 because when the slat 16 adjacent the lower edge 22b is rolled onto the roller 38, previous windings of the support sheet 22 and slats 16 are already wrapped about the roller 38 and thus the effective diameter of the roller 38 includes the additional radial thickness of the support sheet 22 and the slats 16 positioned above the lower slat 16. By forming the slat 16 adjacent the lower edge 22b with a larger radius of curvature R4, the covering element 12 may be tightly rolled onto the roller 38, resulting in a smaller overall roll-up diameter of the covering element 12 about the roller 38.

To form the slats 16 into a coved or curved profile, the slats 16 initially may have a flat or rectangular profile (see FIG. 7) and may be attached to the support sheet 22. Adhesive 28 may be applied to the rear faces 26 of the slats 16 to form adhesive bonds between the entire rear faces 26 of the slats 16 and the support sheet 22. In other words, the slats 16 may be adhesively applied to the support sheet 22 in a flat configuration. Multiple slats 16 may be laid adjacent to one another across the support sheet 22 with gaps 20 defined between the adjacent slats 16. The combination of the support sheet 22, the slats 16, and the adhesive 28 may be rolled tightly onto the roller 38 such that the slats 16 conform to the curvature of the roller 38 (see FIG. 8). The slats 16 may be sufficiently flexible or resilient to endure the mechanical deformation of the slats 16 caused by being rolled tightly onto the roller 38.

With reference to FIG. 8, during the forming process, the covering element 12 and the roller 38 may be positioned on a support surface 40, such as a table top. The roller 38 may be rotated about its longitudinal axis 42 in a retraction direction 44 to wrap the covering element 12 about the roller 38. A work piece 46, which may be formed as an angle having an L-shaped cross-section or profile, may apply a radial force F to the covering element 12 as the covering element 12 is wrapped around the roller 38 to enhance the tightness of the wrapped covering element 12 about the roller 38. The work piece 46 may apply compression, tension, or both to the covering element 12. In some implementations, a free edge 22b of the support sheet 22 may be held in place and the roller 38 may be rotated in the retraction direction 44 to enhance the tightness of the covering element 12 about the roller 38. In some implementations, the roller 38 may be rotationally fixed and a free edge 22b of the support sheet 22 may be moved in an extension direction to enhance the tightness of the covering element 12 about the roller 38.

With reference to FIG. 9, after the covering element 12 is wrapped about the roller 38, heat 48 may be applied to raise the temperature of the slats 16 above the softening point of the slats 16. As the slats 16 are softened, the resiliency of the slats 16 to return to a flat configuration may be removed such that the slats 16 may maintain the curvature corresponding to the radius of curvature of the roller 38 and the inner windings of the covering element 12. In some implementations, the slats 16 are heated to a temperature of about 180 degrees Fahrenheit, which may be between about 10 degrees and about 15 degrees Fahrenheit above the softening point of the material of the slats 16, and held at that temperature for a time of about 1 hour.

After the slats 16 are conformed to their respective profiles and while the blind member 14 is still wrapped about the roller 38, the combination of the support sheet 22, the slats 16, and the adhesive 28 may be cooled below the softening point of the slats 16 to set the curvature of all of the slats 16 to a coved or curved profile matching the combined diameter of the roller 38 and the rolled-up portion of the covering element 12 at the respective slats 16 position on the support sheet 22. In other words, the slats 16 positioned closer to the lower edge 22b of the support sheet 22 may have a larger radius of curvature than the slats 16 positioned closer to the upper edge 22a of the support sheet 22. Stated differently, the radius of curvature of the slats 16 may increase from the upper edge 22a of the support sheet 22 to the lower edge 22b of the support sheet 22 to provide the tightest roll up diameter of the covering element 12 about the roller 38. As shown in FIG. 2, one of the slats 16 positioned adjacent the lower edge 22b of the support sheet 22 may have a radius of curvature R3, which may be greater than a radius of curvature R4 of one of the slats 16 positioned adjacent the upper edge 22a of the support sheet 22, as previously discussed.

The slats 16 may be made of Polyvinyl Chloride (PVC) or other suitable materials having sufficient rigidity or stiffness. For instance, the slats 16 may be made from various types of materials including aluminum, fiber-reinforced materials, pultruded glass, coated fabric, nonwoven materials, wood veneer, and the like. The slats 16 may be coated, printed, transfer printed, dyed, embossed, laminated, punched, die cut, or otherwise treated to provide a number of different aesthetic and light-controlling attributes to the covering 10. In some implementations, a heat transfer foil is used to impart a wood grain appearance on the surface of the slats 16. The treatment applied to slats 16 may be matched with the support sheet 22 to create a compliment or contrast that enhances the aesthetics of the covering 10. In some implementations, the slats 16 have a thickness of about 15 mils.

In some implementations, the slats 16 may be pre-formed to substantially the diameter of the roller 38. For example, the slats 16 may be pre-formed in implementations where the slat 16 is made of a material that cannot be applied flat, softened, and then shaped on the roller 38. To pre-form the slats 16, shaping dies may apply pressure to the slats 16 to form the slats 16 into the desired profile. Then, the rear face 26 of the pre-formed slat 16 may be attached to the support sheet 22. Although this pre-forming process may result in a covering element 12 that does not roll up as tightly as the shaped-in-place slats 16 described previously, the covering element 12 may be reasonably tightly wound about the roller 38 because the radius of the pre-formed slats 16 and the radius of the roller 38 may be substantially matched.

The support sheet 22 may be constructed of a single, continuous length of material or may be constructed of multiple strips of material attached or joined together in an edge-to-edge, overlapping, or other suitable relationship. The support sheet 24 may be constructed of substantially any type of material. For example, the support sheet 24 may be constructed from natural and/or synthetic materials, including fabrics, films, polymers, and/or other suitable materials. Fabric materials may include woven, non-woven, knits, or other suitable fabric types. In some implementations, the support sheet 22 is constructed of a fabric named Glen Raven Sur Last and is a solution-dyed Polyester designed for exterior use. This material is a woven continuous filament polyester fabric with a water repellant coating on its back side.

The slats 16 and the support sheet 22 may have any suitable level of light transmissivity. For example, the slats 16 and the support sheet 22 may be constructed of transparent, translucent, and/or opaque materials to provide a desired ambience or décor in an associated area or room. In some examples, the support sheet 22 is transparent and/or translucent, and the slats 16 are translucent and/or opaque. In some examples, the slats 16 have zero light transmissivity. When the covering element 12 is in an extended position, light may pass through the support sheet 22 between the slats 16 to create horizontal or substantially horizontal light stripes. The support sheet 22 may include patterns or designs to create a unique aesthetic appearance.

Although not depicted, the covering 10 may include a drive or operating mechanism configured to raise or retract the covering element 12. The operating mechanism may be controlled mechanically and/or electrically. The operating mechanism may include a speed governing device to control or regulate the extension or lowering speed of covering element 12. In some examples, the operating mechanism may include an electric motor configured to extend or retract the covering element 12 upon receiving an extension or retraction command. The motor may be hard-wired to a switch and/or operably coupled to a receiver that is operable to communicate with a transmitter, such as a remote control unit, to permit a user to control the motor and thus the extension and retraction of the covering element 12. The motor may include a gravity lower state to permit the covering element 12 to lower via gravity without motor intervention, thereby reducing power consumption. In some examples, the covering 10 may include a spring operably coupled to the roller 38 to counterbalance the weight of the portion of the covering element 12 suspended from the roller 38 such that a user may grasp a lower edge of the covering element 12, move the covering element 12 to a desired position, and then release the covering element 12, with the counterbalance spring holding the covering element 12 in the desired position.

The foregoing discussion has been presented for purposes of illustration and description and is not intended to limit the disclosure to the form or forms disclosed herein. While a preferred embodiment is shown and described in detail, it should be appreciated that alternate embodiments may exist using slats adhered to a sheet to provide lateral, cross sheet stiffness to the covering for tracking and retracking of the covering. For example, while adhesive is the preferred method of joining the slats to the support sheet, the slats additionally or alternatively may be ultrasonically welded to the sheet, sewn to the sheet, heat welded to the sheet, stapled to the sheet, or otherwise connected to the sheet in a manner that fixedly attaches the slats to the support sheet. Various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

1. A covering for an architectural opening, comprising:
a roller;
a sheet attached to the roller; and
at least two slats attached to the sheet and extending lengthwise across a width of the sheet, the at least two slats spaced apart from one another to define a gap between adjacent slats of the at least two slats, the at least two slats having an arcuate profile, wherein the at least two slats and the sheet are rollable onto and unrollable from the roller.

2. The covering according to claim 1, wherein the at least two slats have different radii relative to one another.

3. The covering according to claim 1, wherein:
the at least two slats comprise a first slat positioned adjacent an upper edge of the sheet and a second slat positioned adjacent a lower edge of the sheet;
the first slat has a first radius of curvature; and
the second slat has a second radius of curvature larger than the first radius of curvature.

4. The covering according to claim 1, wherein the at least two slats have substantially the same radius as the roller.

5. The covering according to claim 1, wherein the at least two slats extend across an entire width of the sheet.

6. The covering according to claim 1, further comprising a guide frame that overlaps end portions of the at least two slats.

7. The covering according to claim 1, wherein the adjacent slats are parallel to one another.

8. The covering according to claim 1, wherein the at least two slats extend horizontally across a face of the sheet.

9. The covering according to claim 1, wherein the at least two slats are attached to the sheet with an adhesive.

10. The covering according to claim 1, wherein the at least two slats include rear faces extending coextensively with and attached to the sheet.

11. The covering according to claim 1, wherein the at least two slats include upper and lower edges that are attached to a face of the sheet.

12. The covering according to claim 1, wherein the sheet is constructed of one piece of material.

13. The covering according to claim 1, wherein the gap has a constant width along the length of the adjacent slats.

14. The covering according to claim 1, wherein the gap has a width that is less than a width of the adjacent slats.

15. The covering according to claim 1, wherein a width of each slat of the at least two slats is about one inch.

16. The covering according to claim 1, wherein the at least two slats is comprised of one or more materials selected from the group of materials including polyvinylchloride, thermoplastic polymers, thermosetting polymers, aluminum, wood veneer, fiberglass, nonwoven, or coated fabrics.

17. The covering according to claim 1, wherein the sheet is comprised of one or more materials selected from the group of materials including polymer coated woven glass yarns, polymer coated woven polyester yarns, knits, woven, nonwoven, or film.

18. A method of shaping a slat of a covering for an architectural opening, comprising:
attaching at least two slats to a sheet;
rolling the sheet and the at least two slats about a roller to mechanically conform a shape of the at least two slats to a radius of curvature defined at least partially by the roller; and
heating the at least two slats after conforming the shape of the at least two slats to the radius of curvature defined at least partially by the roller.

19. The method according to claim 18, further comprising cooling the at least two slats after heating the at least two slats.

20. The method according to claim 18, wherein the attaching at least two slats to a sheet comprises attaching at least two slats having a rectangular profile to a sheet.

21. The method according to claim 18, wherein the slats are formed from a material which retains the curvature defined by the roller when the covering is in an extended position.

22. The covering according to claim 1, wherein the slats are sufficiently stiff to provide cross-sheet stiffness to the sheet.

23. The covering according to claim 1, wherein the slats are sufficiently stiff to retain an arcuate profile when the covering is in an extended position.
